(19) United States
(12) Patent Application Publication
(10) Pub. No.: US 2023/0077293 A1
(43) Pub. Date: Mar. 9, 2023

(54) TRACER EVENTS

(71) Applicant: Twitter, Inc., San Francisco, CA (US)

(72) Inventors: Lohit Vijaya Renu, Santa Clara, CA (US); Zhenzhao Wang, San Francisco, CA (US)

(21) Appl. No.: 17/877,069

(22) Filed: Jul. 29, 2022

Related U.S. Application Data
(60) Provisional application No. 63/240,600, filed on Sep. 3, 2021.

(51) Int. Cl. G06F 11/34; G06F 11/28

(52) U.S. Cl. CPC G06F 11/34; G06F 11/28

(57) ABSTRACT

Methods, systems, and apparatus, including computer programs encoded on computer storage media, for generating tracer events. One of the methods includes generating, by a first system in an event processing pipeline, tracer event data for a data event; receiving, by a downstream system in the event processing pipeline, data for the data event and the tracer event data for the data event; updating, by the downstream system, the tracer event data for the data event using metric data generated while the downstream system processed the data event; after updating the tracer event data, receiving the data event that has been processed at each of multiple different layers in the event processing pipeline, and the updated tracer event data for the data event; and causing a change to the event processing pipeline using a result of an analysis of the updated tracer event data.

### CROSS-REFERENCE TO RELATED APPLICATIONS

This application claims the benefit under 35 U.S.C. § 119(e) of the filing date of U.S. Patent Application No. 63/240,600, entitled “TRACER EVENTS,” which was filed on Sep. 3, 2021, and which is incorporated here by reference.

### BACKGROUND

This specification relates to processing metric data generated by multiple different systems in an event processing pipeline.

Devices can store data in non-persistent or persistent memory. For instance, a device can store data in persistent memory within a database.

Client devices can send requests to servers. The requests can be for retrieval of data, e.g., retrieval of a web page or search results, or for storage of data. For instance, a client device can request that a server store data on the server, e.g., when the server is part of a cloud system.

### SUMMARY

To enable a system in an event processing pipeline to capture metrics for events processed by multiple different systems, and to perform automated actions based on those metrics, the system uses tracer events. A tracer event can be a data event that includes additional data, e.g., fields, that include metrics data for a system that processed the event. In some examples, a tracer event can be a separate event that includes metrics data for multiple different events, each of which are processed by multiple different systems in the event processing pipeline. The system can analyze the metrics data from the tracer events to determine whether to adjust one or more parameters of the event processing pipeline. Some example parameter adjustments can include adding or removing one or more systems to a layer within the event processing pipeline, swapping out one of the multiple different systems with another system, adding a layer to the event processing pipeline, or a combination of two or more of these.

In general, one aspect of the subject matter described in this specification can be embodied in methods that include the actions of generating, by a first system in an event processing pipeline that includes a plurality of systems within one or more layers a) including a last layer and b) at least some layers of which perform different event processing on an event that passes through the event processing pipeline after the event is processed by an initiating layer, tracer event data for a data event; receiving, by a downstream system in the event processing pipeline that is included in a different layer from the layer that includes the first system, i) data for the data event and ii) the tracer event data for the data event; processing, by the downstream system, the data event; updating, by the downstream system, the tracer event data for the data event using metric data generated while the downstream system processed the data event; providing, by the downstream system and for a second downstream system in the event processing pipeline, the updated tracer event data, wherein the second downstream system is included in a different layer from the layer that includes the downstream system; after updating the tracer event data, receiving, by a last system in the last layer of the event processing pipeline and from another system in the event processing pipeline, i) the data event that has been processed at each of multiple different layers in the event processing pipeline, and ii) the updated tracer event data for the data event; analyzing the updated tracer event data; and causing a change to the event processing pipeline using a result of the analysis of the updated tracer event data.

The foregoing and other embodiments can each optionally include one or more of the following features, alone or in combination. Causing the change to the event processing pipeline can include causing the change to one or more parameters for a system from one of the multiple different layers in the event processing pipeline using the result of the analysis of the updated tracer event data. Causing the change to the one or more parameters for the system can include causing auto-scaling for the system from one of the multiple different layers in the event processing pipeline using the result of the analysis of the updated tracer event data.

In some implementations, the method can include storing, in a database, an entry for the data event that includes the updated tracer event data for the data event. Storing the entry for the data event can include storing, in the database, the entry for the data event that includes event data in a first column of the database and only tracer event data for the data event in a second column of the database. Storing the entry for the data event can include storing, in the database, the entry for the data event that includes event data with less restrictive permissions and tracer event data for the data event with more restrictive permissions that are more restrictive than the less restrictive permissions. Receiving i) the data event and ii) the updated tracer event data for the data event can include receiving, by the last system, a message that includes i) the data event that has been processed at each of multiple different systems in the event processing pipeline, and, ii) for each metrics-enabled system in the event processing pipeline, a field that includes tracer event data generated by the corresponding metrics-enabled system and an identifier for the corresponding metrics-enabled system. Storing the entry for the data event can include storing the entry for the data event that includes data for the data event and, for each of the metrics-enabled systems, a) the corresponding tracer event data generated by and, b) the identifier for, the corresponding metrics-enabled system. The method can include storing, in a database and for each of two or more data events that includes the data event, an entry for the respective event that includes the corresponding tracer event data for the respective event.

In some implementations, receiving i) the data event and ii) the updated tracer event data for the data event can include receiving, by the last system in the event processing pipeline, two or more data events including the data event; and after receiving the two or more data events, receiving, by the last system in the event processing pipeline, a plurality of tracer event data a) that includes the tracer event data and b) is for the two or more data events including the data event. Receiving the plurality of tracer event data for the two or more data events can include receiving, by the last system in the event processing pipeline and after receiving the two or more data events, tracer event data for each of the two or more data events. Receiving the plurality of tracer event data for the two or more data events can include receiving, by the last system in the event processing pipeline and after receiving the two or more data events, data that includes, for each of multiple events from the two or more data events, i) an identifier for and, ii) tracer event data generated during processing of, the corresponding event. Receiving the two or more data events can include receiving a predetermined number of events. Receiving the two or more data events can include receiving, during a predetermined period of time, the two or more data events.

In some implementations, receiving i) the data event and ii) the updated tracer event data for the data event can include receiving, by the last system in the event processing pipeline, the data event that has been processed at each of multiple different systems in the event processing pipeline, at least some of which multiple different systems have platforms different from platforms of other systems included in the multiple different systems.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various embodiments and may result in one or more of the following advantages. In some implementations, the systems and methods described in this specification, e.g., the use of tracer events, enables an event processing pipeline to more quickly detect and remove processing bottlenecks. This can enable the event processing pipeline, e.g., a recommendation system, to more quickly have the most recent data events and make more accurate recommendations using the most recent data events compared to when the recommendation system does not have the most recent data events. In some implementations, the systems and methods described in this specification can enable more robust analysis of the tracer event metrics using a database entry that includes both the data event and the corresponding tracer event than other systems that only have access to the metric data. This can cause the analyzing system to be more accurate than other systems that store metrics data separate from the data for which the metrics were generated.

In some implementations, the systems and methods described in this specification that embed tracer events, e.g., mutable tracer events, in an event stream, store tracer events in a database with the corresponding data events, or both, can maintain the tracer event metrics without relying on another system, a system that stores only metrics data, or both. This can reduce computer resource usage, power usage, or both.

In some implementations, the systems and methods described in this specification, e.g., the use of tracer events, can enable an event processing pipeline to gather metrics from systems included in the event processing pipeline from which the event processing pipeline might not be able to gather metrics otherwise. This can enable the event processing pipeline to better identify and take corrective action for system inefficiencies. For example, the use of tracer events can enable an event processing pipeline to improve the performance of a system in the event processing pipeline, where the inefficiencies of such a system might have remained undetected if the event processing pipeline did not use tracer events. In some implementations, use of tracer events can enable detection of event processing pipeline inefficiencies in real-time or near real-time. This can enable systems and methods that use tracer events to optimize an event processing pipeline, e.g., for better results, better processing, or both, more quickly than other systems and methods.

In some implementations, the systems and method described in this specification can collect metrics in a non-intrusive manner, agnostically from the internal systems in an event processing pipeline, or both. For instance, an event processing pipeline can collect metrics in a non-intrusive manner because the event processing pipeline does not require changes to the underlying systems for use of tracer events. Instead, the event processing pipeline can work with existing systems. In some examples, an event processing pipeline can collect metrics using tracer events that will still work regardless of any changes to the individual systems within the event processing pipeline. For instance, the event processing pipeline will still be able to collect metrics using tracer events if any particular system is added, replaced, or otherwise modified.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment of an event processing pipeline for generating tracer events.

FIG. 2 is a flow diagram of an example process for changing a parameter in an event processing pipeline using tracer event data.

Like reference numbers and designations in the various drawings indicate like elements.

### DETAILED DESCRIPTION

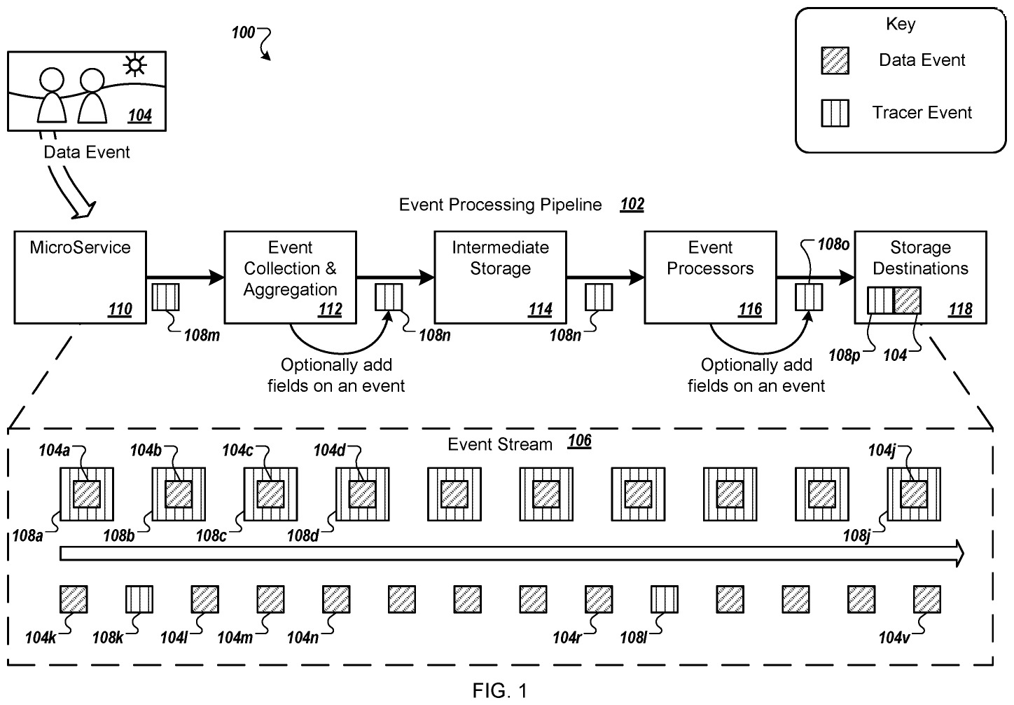

FIG. 1 depicts an example environment 100 of an event processing pipeline 102 for generating tracer events. The event processing pipeline 102 can be a complex platform infrastructure that performs a variety of operations on data events 104 that pass through the event processing pipeline 102 on an event stream 106. For example, the event processing pipeline 102 can include multiple layers that each process events that pass through the event processing pipeline 102. Some examples of the multiple layers can include a micro-service layer, an event collection and aggregation layer, an intermediate storage layer, an event processor layer, and a storage destination layer. Each of the layers can include one or more corresponding systems, such as a micro-service 110 that generates data events, an event collection and aggregation system 112 that collects and aggregates data for data events, an intermediate storage 114, one or more event processors 116, and one or more storage destinations 118. The storage destinations 118 can include persistent storage for storing the data events 104. Although this application describes steps performed by a system in one of the layers, the steps can be performed by a combination of systems included in the respective layer.

The storage destinations 118 can provide data for the data events 104 to other systems. For instance, the storage destinations 118 can receive queries for data events 104 from client devices, recommendation systems, or a combination of both. In some examples, the storage destinations 118 can, as part of a recommendation system, provide data events to client devices.

For the storage destinations 118 to provide accurate data, the storage destinations 118 need to maintain, in storage, the most recent data events 104, e.g., as quickly as possible. If a system in the event processing pipeline 102 introduces a bottleneck, or another processing inefficiency, the storage destinations 118 will provide less accurate data, such as responses to queries, than if the bottleneck did not exist and the storage destinations 118 had the most recent data events 104.

In some environments, thousands of micro-services 110 can emit events. The data events 104 can be messages, e.g., tweets, images, or other appropriate content. The thousands of micro-services 110 together can emit event billions of events per minute. This can cause the event processing pipeline 102 to operate at tens of terabytes of data per minute.

The event processing pipeline 102 can include the event stream 106 that passes data events 104 through the various systems of the event processing pipeline 102, including the micro-service 110, the event collection and aggregation system 112, the intermediate storage 114, e.g., a message queue, the one or more event processors 116, e.g., that consume data from the message queue, and the one or more storage destinations 118. Some implementations can include more or fewer layers in the event processing pipeline 102, e.g., compared to the five layers depicted in FIG. 1.

The data events 104 can be analyzed and processed at various systems in the event processing pipeline 102 for analytics, queries, or both. For instance, the event collection and aggregation system 112 can generate analytics for the data events 104. The event processors 116 can apply one or more transformations to data events 104 consumed from the intermediate storage 114. The event processors 116 can provide transformed data events 104 to the one or more storage destinations 118.

The one or more storage destinations 118 can store the data events for consumption by various applications, e.g., client applications, systems, or both. For example, a storage destination 118 can store an image as a data event 104. The storage destination 118 can receive a request for the image for presentation in a native application, or a web application. The storage destination 118 can retrieve the image, as a data event 104, from persistent storage and provide the image, e.g., using a network, for presentation in the requesting application.

In some implementations, some of the various systems in the event processing pipeline 102 can be operated by different entities, while the event processing pipeline 102 itself is for a single entity. For instance, some of the various systems in the event processing pipeline 102 can be cloud services offered by different cloud service providers. The event processing pipeline 102 itself can process events for a single entity, e.g., an entity that develops an application that generates data events 104, consumes data events 104, or a combination of both.

To enable the event processing pipeline 102 to generate metrics for at least some of the systems in the event processing pipeline 102 that are operated by different entities, the event processing pipeline 102 uses tracer events 108a-p. Because some of the systems in the event processing pipeline 102 might not be, or are not, operated directly by the entity for which the data events 104 are generated, the entity might not, or does not, have control over all of the systems in the event processing pipeline 102 to enable metric generation. For instance, the entity might operate the event collection and aggregation system 112 and the storage destinations 118, while the micro-service 110, the intermediate storage 114, and the one or more event processors 116 are operated by different entities, e.g., two or more entities. This configuration can prevent the entity from instrumenting, e.g., programming, each of the systems in the event processing pipeline 102 to emit metrics which can be collected in a common metrics store. For example, some of the systems in the event processing pipeline 102 might be closed source or hosted solutions that prevent the entity from instrumenting the corresponding system to generate metrics.

The micro-service 110 generates the initial tracer events 108a-p. After generation, the micro-service 110 places the tracer events 108a-p on the event stream 106 on which the data events 104 pass through the event processing pipeline 102. As the tracer events 108a-p pass through the event processing pipeline 102, various systems within the event processing pipeline 102 update the tracer events.

In some implementations, the systems that update the tracer events 108a-p are those that are configured to emit metrics data. These systems can include systems that have an application programming interface (“API”), built in metrics method calls, another mechanism, or a combination of these, that provides access to metrics generated by the corresponding system. These systems can include systems operated by the entity that develops an application for the data events 104.

For example, the micro-service 110 can generate a tracer event 108m for the data event 104. The micro-service 110 can place the tracer event 108m on the event stream 106 along with the data event 104.

While the tracer event 108m and the corresponding data event 104 are on the event stream 106, systems in the event processing pipeline 102 can intercept and update the tracer event 108m. For instance, the event collection and aggregation system 112 can add a field to the tracer event 108m to create an updated tracer event 108n. The updated tracer event 108n includes metrics generated by the event collection and aggregation system 112.

The metrics can include metrics for the processing of the data event 104 for which the tracer event 108m was generated. For instance, the metrics can include one or more of event latency; event drop rate; event drop count; event arrival rate; event data quality checks; event throughput rate; end-to-end statistics; event modification time; malformed event count; corrupted event count; event size distribution; or other appropriate system metrics. One or more of these metrics can be determined based on the processing of the event by the event collection and aggregation system 112. The metrics can include rates or counts for various ones of the metrics described above or otherwise in this specification.

In some examples, the tracer event 108m can include various metrics, e.g., before the tracer event 108m is added to the event stream 106. In some implementations, a downstream system, such as the event collection and aggregation system 112, can add at least some of these metrics to the tracer event 108m. These metrics can relate to the event, the service that generated the event, or other appropriate metrics. For instance, these metrics can include one or more of event type, service type, sampling rate, event generation time, event count, host metrics, event drop rate, event drop count, malformed event count, corrupted event count, event size distribution, client identifier, or service identifier. A client identifier or a service identifier can be a universally unique identifier (“UUID”), an Internet Protocol (“IP”) address, or another appropriate identifier.

The types of metrics included in the tracer events 108a-p can be configured, e.g., based on the corresponding data event type or other appropriate data. For example, an image event can have a first set of metric data and a message event can have a second, different set of metric data. When a system in the event processing pipeline 102 processes a tracer event 108a-p event for the corresponding data event 104a-v, the system can add metrics to the tracer event 108a-p based on the corresponding data event 104a-v type. In some examples, the system can add metrics to the tracer event 108a-p based on the types of metrics that the system is configured to provide, e.g., using an API.

In some examples, the intermediate storage 114, or another system in the event processing pipeline 102, is not configured to add metrics to the updated tracer event 108n. In these examples, the intermediate storage 114 need not intercept the updated tracer event 108n. Instead, the updated tracer event 108n can pass along the event stream 106, past the intermediate storage 114 without any additional or changed metric data added to the updated tracer event 108n. In some examples, the intermediate storage 114 intercepts the updated tracer event 108n and provides the updated tracer event 108n, without any additional or changed metric data, to a downstream system.

The event processors 116 can intercept the updated tracer event 108n and add one or more fields to the updated tracer event 108n. By way of this addition of one or more fields, the event processors 116 can generate a twice updated tracer event 1080. The event processors 116 can add any appropriate metrics data to the updated tracer event 108n to generate the twice updated tracer event 1080. For instance, the event processors 116 can add metrics data to a field, such as a newly created field added onto the updated tracer event 108n, as described in more detail above with respect to the event collection and aggregation system 112, the micro-service 110, or both.

When the event stream 106 terminates in the storage destinations 118, the storage destinations 118 can store the data event 104 and the corresponding twice updated tracer event 108o in storage. For instance, the storage destinations 118 can create a new entry in a database for the data event 104. The new entry can include a field for the data from the twice updated tracer event 108p. For example, the new entry can include one or more columns for the data event 104 and one or more additional columns for data from the twice updated tracer event 1080.

Storage of the tracer event 108p with the corresponding data event 104 can enable the event processing pipeline 102, or another system outside the event processing pipeline 102, to determine important metrics for the event stream 106. For instance, the analyzing system can perform more robust analysis of the tracer event metrics using a database entry that includes both the data event and the corresponding tracer event than if the analyzing system only had access to metric data. This can cause the analyzing system to be more accurate than other systems that store metrics data separate from the data for which the metrics were generated. For example, because tracer events live with the corresponding source data events, an analyzing system can trace back to the timeline of events to understand metrics about the event stream 106.

In some implementations, the tracer events 108m-p can be mutable tracer events 108a-j. A mutable tracer event 108a-j is a tracer event to which new fields can be added by individual systems in the event processing pipeline 102. Although the event processing pipeline 102 can generally prefer to have immutable features for data events 104, or only allow for immutable features for data events, the event processing pipeline 102 can relax this restriction for tracer events 108. In these implementations, the event processing pipeline 102 can provide the option of adding new fields only to a mutable tracer event 108a-j as the mutable tracer event passes through the event stream 106. This can include the event processing pipeline 102 preventing the systems in the event processing pipeline 102 from modifying existing fields in mutable tracer events 108a-j.

The micro-service 110 can generate multiple data events 104a-j and place each of the multiple data events 104a-j on the event stream 106. These multiple data events 104a-j can each include a corresponding mutable tracer event 108a-j, respectively, e.g., as encapsulated events. Specifically, when the micro-service 110 generates a first data event 104a, the micro-service 110 includes a first mutable tracer event 108a as part of the first data event 104a. The micro-service 110 then places the first data event 104a with the first mutable tracer event 108a on the event stream 106.

This enables downstream systems in the event processing pipeline 102 to intercept and process the first data event 104a. The downstream systems can intercept and modify, e.g., add fields to, the first mutable tracer event 108a. For example, the event collection and aggregation system 112 can intercept the first data event 104a at particular time and add a receipt timestamp for the particular time to the first mutable tracer event 108a.

The micro-service 110 can similarly generate additional data events 104b-j and corresponding mutable tracer events 108b-j, respectively. Each of the additional data events 104b-j can include the corresponding mutable tracer event 108b-j. The micro-service 110 can place the additional data events 104b-j, which include the corresponding mutable tracer events 108b-j, on the event stream 106.

The storage destinations 118 can receive the data events 104a-j that include the corresponding mutable tracer events 108a-j and store each pair of a data event with the corresponding mutable tracer event in a database entry. This can enable an analyzing system to look at the event timeline for the event processing pipeline 102 by querying fields of the mutable tracer events 108a-j stored in the database. For example, the analyzing system can determine the latency of the event processing pipeline 102, the latency between various systems in the event processing pipeline 102, or both, using the metrics stored in the database from the mutable tracer events 108a-j. The latency of the various systems can indicate a load for the system and whether the system is satisfying a threshold processing time, e.g., maximum processing time, given the load. Other metrics, alone or in combination with the latency, can indicate whether a system is efficiently processing the system's load.

In some implementations, the mutable tracer events can be encapsulated events. For instance, the micro-service 110 can generate an encapsulated mutable tracer event that wraps around the corresponding data event. In these implementations, the micro-service 110 can generate the first data event 104a. The micro-service 110 can wrap a first mutable tracer event 108a around the first data event 104a.

When the micro-service 110 places the first mutable tracer event 108a that wraps around the first data event 104a on the event stream 106, various systems in the event processing pipeline 102 can intercept the first mutable tracer event 108a. A first system can add data to the first mutable tracer event 108a, such as the event collection and aggregation system 112. The first system does this by intercepting the first mutable tracer event 108a, processing the first data event 104a that was wrapped within the first mutable tracer event 108a, and adding one or more fields to the first mutable tracer event 108a that include metrics for the processing of the first data event 104a.

A second system, e.g., the intermediate storage 114, might not be configured to add a field to mutable data events. This can occur when the second system does not include an API that provides access to metrics data, the entity does not operate the second system, or both. The second system can intercept the first mutable tracer event 108a and process the first mutable tracer event 108a without adding any additional fields to the first mutable tracer event 108a. For example, the second system can process the first mutable tracer event 108a as if it only included the first data event 104a without consideration for the metrics data included in the first mutable tracer event 108a.

Tracer events 108a-p can include one or more security mechanisms to prevent downstream systems and other unauthorized systems from accessing the metrics stored in the tracer event 108a-p by a prior system. For instance, the tracer event 108m can include an access policy or authorization. The access policy or authorization can indicate that a system that added metrics to the tracer event 108a-p can access the metrics, along with the storage destinations 118, an analysis system, or both. The access policy or authorization can indicate that any other systems in the event processing pipeline 102, e.g., downstream systems, should not be allowed access to the metrics added by the system. The access policy or authorization can be on a per system, e.g., in the event processing pipeline 102, basis.

In some examples, a system adding metrics to a tracer event 108a-p can encrypt the metrics so that only authorized systems can decrypt the metrics. The system can use an encryption process with an encryption key. Only authorized systems can have the decryption key that corresponds to the encryption key. The authorized systems can include the system that encrypted the metrics, e.g., for possible updates to the metrics, the storage destinations 118, an analysis system, or a combination of two or more of these.

In some implementations, the mutable tracer events can be standalone events. A standalone mutable tracer event 108k-l can include metrics data for multiple different data events. For instance, a first standalone mutable tracer event 108k can include metrics data for multiple data events 104l-r. A standalone mutable tracer event can act like a summary event for the multiple different data events sent by the micro-service 110. A standalone mutable tracer event 108k-l does not include the corresponding data event 104l-v. For example, the event stream 106 includes separate data events 104l-v for which the standalone mutable tracer event 108k-l contains metrics.

For example, the micro-service 110 can generate, and place on the event stream 106, the multiple different data events 104l-r. The micro-service 110 can generate a standalone mutable tracer event 108k for the multiple different data events 104l-r. This standalone mutable tracer event 108k can include metrics data for each of the multiple different data events 104l-r, such as the creation time for each of the multiple different data events 104l-r, e.g., when the standalone mutable tracer event 108k reaches the storage destinations 118.

The micro-service 110 can place the standalone mutable tracer event 108k on the event stream 106, e.g., after placing the multiple different data events 104l-r on the event stream 106. A system in the event processing pipeline 102 can accumulate metrics for processing the multiple different data events 104l-r. When the system intercepts the standalone mutable tracer event 108k, the system can add additional fields to the standalone mutable tracer event 108k and store the accumulated metrics in the additional fields.

When the storage destinations 118 receive the standalone mutable tracer event 108k, e.g., after receipt of the multiple different data events 104l-r, the storage destinations 118 can update entries in a database for the corresponding multiple different data events 104l-r. For instance, the storage destinations 118 can access an entry for a second data event 104l and update the entry with metrics data from the standalone mutable tracer event 108k that corresponds to the second data event 1041.

The standalone mutable tracer event 108k can include one or more identifiers. A first identifier for data in the standalone mutable tracer event 108k, e.g., for a field in the mutable tracer event, can indicate the data events 104l-r to which the tracer event data corresponds. A second identifier for the data in the standalone mutable tracer event 108k can indicate the metrics-enabled system in the event processing pipeline 102 that generated the tracer event data.

In some examples, the standalone mutable tracer event 108k can include identifiers for each of the multiple different data events 104l-r to which the standalone mutable tracer event 108k corresponds. When a system in the event processing pipeline 102 adds metrics to the standalone mutable tracer event 108k, e.g., in a new field, the system can include an identifier for the data event to which the metrics correspond and an identifier for the system.

The micro-service 110 can generate a standalone mutable tracer event 108k when a generation threshold is satisfied. The generation threshold can be a predetermined period of time, e.g., every X minutes. The generation threshold can be a predetermined quantity of data events, e.g., for every 1,000 data events. In some examples, the generation threshold can be determined dynamically, e.g., using metrics for the event processing pipeline 102 such as load, throughput, or both.

In some implementations, the micro-service 110 generates either an encapsulated mutable tracer event or a standalone mutable tracer event, but not both. For instance, the micro-service 110 can generate only the standalone mutable tracer event 108k without generating the encapsulated mutable tracer event 108a.

In some implementations, the micro-service 110 can generate both encapsulated mutable tracer events and standalone mutable tracer events. In these implementations, systems in the event processing pipeline 102 can include different types of metrics in the different types of mutable tracer events. For example, a system can include metrics specific to a first data event 104a in the corresponding encapsulated mutable tracer event 108a and metrics for the system itself in a standalone mutable tracer event 108k. In this example, the system can include an identifier for the system in the standalone mutable tracer event 108k, along with the corresponding metrics, and need not include event identifiers.

When the storage destinations 118 receive both an encapsulated mutable tracer event and a standalone mutable tracer event that include metrics for a data event, the storage destinations 118 can store the metrics in a single database entry for the data event or different database entries. The different database entries can be for the data event, for the system that generated the metrics data, for the event processing pipeline 102, or a combination of these. In some examples, some of the different database entries can be stored in different databases.

By embedding the mutable tracer events 108a-p in the event stream 106, the event processing pipeline 102 can maintain the tracer event metrics without relying on another system, a system that stores only metrics data, or both. For instance, the event processing pipeline 102 maintains the tracer events 108a-p in the event stream 106, along with one or more data events 104a-v. Once the tracer events 108a-p have passed through the event stream, the event processing pipeline 102 can maintain the tracer events 108a-p in the storage destinations 118 along with the data events 104a-v.

An analysis system, included in the event processing pipeline 102 or another part of the environment 100, can analyze metrics from the tracer events 108a-v that are maintained in the storage destinations 118. The analysis system can use an analysis of the metrics to identify bottlenecks and other processing efficiencies in the event processing pipeline 102. The processing efficiencies can be represented by one or more threshold values, such as a threshold latency, a threshold throughput, a threshold event count, or a threshold drop rate. For instance, the analysis system can determine that the event collection and aggregation system 112, or a group of event collection and aggregation systems 112, are unable to maintain a threshold latency.

When tracer event metrics do not satisfy the corresponding thresholds, the analysis system can determine that a processing inefficiency exists and to cause a change in the event processing pipeline 102. Depending on the type of threshold, the analysis system can determine that tracer events metrics do not satisfy the corresponding threshold when the metrics are greater than, less than, equal to, greater than or equal to, or less than or equal to the corresponding threshold. For instance, a throughput rate can satisfy a corresponding threshold when it is greater than the threshold. A latency rate can satisfy a corresponding threshold when it is less than the threshold.

For instance, as a result of the analysis, the analysis system can cause a change, e.g., auto-healing or auto-scaling, in one or more systems included in the event processing pipeline 102. For example, when the group of event collection and aggregation systems 112, e.g., in the event collection and aggregation layer, are unable to maintain a threshold latency, the analysis system can cause the event processing pipeline 102 to add one or more additional systems, e.g., servers, to the group of event collection and aggregation systems 112. In some examples, the event processing pipeline 102 can add a layer to the pipeline as a result of the analysis. Such a layer can be added so that the event processing pipeline 102 can satisfy the thresholds. This can include adding a layer between the intermediate storage 114 layer and the event processors 116 layer.

The analysis system can determine a degree to which parameters for the event processing pipeline 102 are changed, e.g., a quantity of additional systems to add, using the metrics data and the corresponding threshold. For instance, the analysis system can determine a greater change when the metrics data is further away from the corresponding threshold compared to when the metrics data is closer to the corresponding threshold.

The event processing pipeline 102 can be a real-time, or near real-time, event processing pipeline. For the event processing pipeline 102 to maintain at least a threshold level of accuracy in responding to queries, providing accurate data to other systems, such as event recommendations for presentation on a client device, or both, the event processing pipeline 102 can continuously monitor metrics from the tracer events 108a-p that were generated by the various systems included in the event processing pipeline 102, at least some of which are not in control of the entity for which the data events 104a-v are generated. The event processing pipeline 102 can use a result of the metric monitoring to determine pipeline inefficiencies and update the pipeline accordingly.

By analyzing events in real-time or near real-time, the event processing pipeline 102 can more quickly update itself for auto-healing, auto-scaling, or both. For instance, when the event processing pipeline 102 detects a problem in real-time or near real-time, the event processing pipeline 102 can more quickly, efficiently, or both, correct the problem using auto-healing, auto-scaling, or both, to improve the overall processing by the event processing pipeline 102.

By using the tracer events, the event processing pipeline 102 can gather metrics from systems included in the event processing pipeline 102 from which the event processing pipeline 102 might not be able to gather metrics otherwise. This can enable the event processing pipeline 102 to better identify and take corrective action for system inefficiencies.

In some implementations, the event processing pipeline 102 maintains the tracer events 108a-p, or metrics from the tracer events 108a-p, transparently in the storage destinations 118 so that general queries for data events 104 do not return data from the tracer events 108a-p. For example, the storage destinations 118 can maintain the data events 104 in one or more first columns in a database while maintaining the tracer events 108a-p in one or more second, different columns in the database. This can enable existing applications to query the storage destinations 118 for data events 104 without retrieving data for the tracer events 108a-p.

In some implementations, the event processing pipeline 102 can provide alerts when one or more processing thresholds are not satisfied. For example, when the event processing pipeline 102 determines that a throughput threshold, an event drop rate threshold, or both, are not satisfied, the event processing pipeline 102 can generate a message about the unsatisfied thresholds. The message can include instructions to cause presentation of a user interface on a recipient device, which user interface includes information about the unsatisfied thresholds. The user interface can include information about a recommended change to the event processing pipeline 102. The user interface can include one or more user interface elements that, upon selection, will cause a recommended change to the event processing pipeline 102.

The systems in the event processing pipeline 102, e.g., the micro-service 110, the event collection and aggregation system 112, the intermediate storage 114, the event processors 116, the storage destinations 118, or a combination of these, are examples of a system implemented as computer programs on one or more computers in one or more locations, in which the systems, components, and techniques described in this specification are implemented. A network (not shown), such as a local area network (LAN), wide area network (WAN), the Internet, or a combination thereof, connects the various systems within the event processing pipeline 102, along with other systems, such as a recommendation system, a client device, or both. The systems in the event processing pipeline 102 can use a single server computer or multiple server computers operating in conjunction with one another, including, for example, a set of remote computers deployed as a cloud computing service.

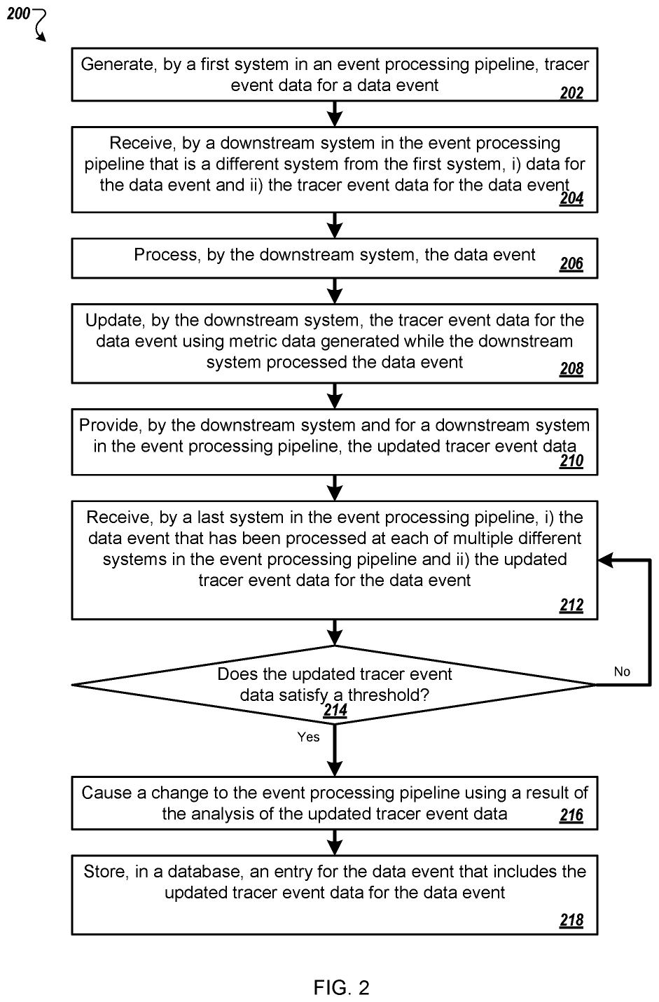

FIG. 2 is a flow diagram of an example process 200 for changing a parameter in an event processing pipeline using tracer event data. For example, the process 200 can be used by the event processing pipeline 102, and various systems or combinations of systems from the event processing pipeline 102, from the environment 100.

A first system in an event processing pipeline generates tracer event data for a data event (202). For instance, the first system can be a service or a micro-service that generates data events. The first system can generate tracer event data for a single data event, e.g., as part of an encapsulated event, for multiple data events, e.g., as a standalone tracer event, or a combination of both.

A downstream system in the event processing pipeline receives i) data for the data event and ii) the tracer event data for the data event (204). The downstream system is a different system from the first system. The downstream system can intercept the data for the data event and the tracer event data, e.g., from an event stream.

The downstream system processes the data event (206). For example, the downstream system can aggregate data events from multiple services or micro-services, store the data event in an intermediate storage, or otherwise process the data event.

The downstream system updates the tracer event data for the data event using metric data generated while the downstream system processed the data event (208). For instance, the downstream system can add an additional field to the tracer event and include the metric data in the additional field. The downstream system might not modify any of the tracer event data in the existing fields of the tracer event.

The downstream system provides, for a downstream system in the event processing pipeline, the updated tracer event data (210). For instance, the downstream system places the updated tracer event data in the event processing pipeline, e.g., on the event stream.

In some examples, the downstream system can provide data for the data event to the downstream system. This can occur when the downstream system removed the data for the data event from the event processing pipeline, when the data event and the tracer event are part of an encapsulated event, or both.

A last system in the event processing pipeline receives i) the data event that has been processed at each of multiple different systems in the event processing pipeline, and ii) the updated tracer event data for the data event (212). In some examples, the last system receives the data event and the updated tracer event data from a second to last system in the event processing pipeline. The second to last system can be the downstream system or a system different than the downstream system that is part of the event processing pipeline. In some examples, the last system receives the data event and the updated tracer event data from the event stream.

The last system can analyze the updated tracer event data, the data for the data event, or both. For instance, the last system can compare one or more metrics in the updated tracer event with corresponding thresholds to determine whether the metrics satisfy the thresholds. For a latency threshold, a corresponding metric can satisfy the latency threshold when the metric is less than, equal to, or less than or equal to the latency threshold. For a drop rate threshold, a corresponding metric can satisfy the drop rate threshold when the metric is less than, equal to, or less than or equal to the latency threshold. For an event count threshold or an event throughput rate threshold, a corresponding metric can satisfy the threshold when the metric is greater than, equal to, or greater than or equal to the threshold. An event count threshold can indicate a number of events for a corresponding system in the event processing pipeline to process. One or more of these thresholds can be static, e.g., predetermined.

In some examples, the event processing pipeline can use one or more dynamic thresholds. For example, the last system can select a threshold based on time of day, day of year, data included in the corresponding event data, or another appropriate criteria. For instance, the last system can have a lower drop rate threshold for a first data event type and a higher drop rate threshold for a second data event type that is different from the first data event type.

The last system determines whether the updated tracer event data satisfies a threshold (214). For instance, as a result of a comparison of the updated tracer event data with the threshold, the last system determines whether the updated tracer event data satisfies the threshold.

The last system causes a change to the event processing pipeline using a result of the analysis of the updated tracer event data (216). For example, the last system can cause the change in response to determining that the updated tracer event data does not satisfy the threshold. The change can include auto-scaling one or more systems, layers, or both, in the event processing pipeline. The change can include auto-healing one or more systems in the event processing pipeline, e.g., when the one or more systems are not performing optimally, or are down, in part or in whole.

The last system can cause the change by sending an instruction to a system in the event processing pipeline. The instruction can cause the event processing pipeline to reconfigure one or more systems already included in the event processing pipeline, add an additional system, a device within a system, or both, to the event processing pipeline, or both. Reconfiguring a system can include causing a change to one or more parameters for a system. Changing the system can include performing auto-scaling one or more layers, systems, or both, in the event processing pipeline.

The last system stores, in a database, an entry for the data event that includes the updated tracer event data for the data event (218). For example, the last system can be a storage destination. The storage destination can include a table. The storage destination can store the data event in one or more first columns in the table and the updated tracer event in one or more second, different columns in the table. In some examples, the last system can store, in the database and for each of two or more data events that includes the data event, an entry for the respective event that includes the corresponding tracer event data for the respective event.

The order of steps in the process 200 described above is illustrative only, and changing the parameter in the event processing pipeline using the tracer event data can be performed in different orders. For example, the last system can receive the updated tracer event data, store the updated tracer event data in a database, e.g., perform step 218, and then determine whether the updated tracer event data satisfies the threshold, e.g., perform step 214. In some examples, the downstream system can process the data event, e.g., perform step 206, substantially concurrently with updating the tracer event data, e.g., performing step 208.

In some implementations, the process 200 can include additional steps, fewer steps, or some of the steps can be divided into multiple steps. For example, storing the entry in the database can include storing, by the last system and in the database, the entry for the data event that includes event data with less restrictive permissions and tracer event data for the data event with more restrictive permissions that are more restrictive than the less restrictive permissions. This can enable the event processing pipeline to maintain the tracer event without exposing the tracer event to all applications, systems, or both, that access the storage destinations.

In some implementations, updating the tracer event data can include adding an identifier for another system in the tracer event data. For instance, the downstream system can generate metrics for processing the data event. The downstream system can add a field to the tracer event, e.g., either an encapsulated tracer event or a standalone tracer event. The downstream system can store the identifier for the downstream system and the generated metrics, or a subset of the generated metrics, in the field. The downstream system can then place the updated tracer event in the event stream. When storing the entry in the database, the last system can include the identifier for the downstream system, as a metrics-enabled system, in the database entry.

In some implementations, another component of the event processing pipeline can perform one or more of the steps of the process 400. For instance, an analysis system in the event processing pipeline can determine whether the updated tracer event data satisfies the threshold, cause a change to the event processing pipeline, or both.

The event processing pipeline can include multiple different platforms. The multiple different platforms can include different applications that process events, such as different operating systems, different cloud systems, or a combination of both. At least some of the multiple different platforms can be operated by different entities.

The event processing pipeline can process a large volume of events, e.g., images, messages, advertisements, or a combination of these. The event processing pipeline can use the tracer events to gather metrics that might otherwise be inaccessible, e.g., by the last system in the event processing pipeline. The event processing pipeline can use the tracer events to make changes to the event processing pipeline to improve the performance of the event processing pipeline when processing events. That these changes might improve the performance of the event processing pipeline might remain undetected if the event processing pipeline did not use tracer events.

In these implementations, a user device can generate an event, e.g., a message such as a tweet. The user device can provide the message to a micro-service for storage of the event in persistent storage. Storage of the event in persistent storage can enable later retrieval, analysis, or both, of the message, e.g., so that the event processing pipeline can provide the message to another device or system.

The micro-service can generate a tracer event for the message to enable a corresponding event processing pipeline to collect metrics about the message. The micro-service can place the message, and the corresponding tracer event, on an event stream.

One or more intermediate systems can process the message and add metrics to the tracer event. For instance, an event collection and aggregation system, and an event processor can add metric data to the tracer event, e.g., in corresponding new fields for the respective systems.

A downstream system, such as a storage destination, receives the message and the corresponding tracer event. The storage destination stores the message and the tracer event in persistent storage.

The storage system, or another system, can analyze the tracer events stored in persistent storage. For example, an analysis system can analyze the tracer events and determine whether the event processing pipeline includes a processing bottleneck that can be auto-healed, auto-scaled, or both, to improve processing inefficiencies.

A system in the event processing pipeline can provide events, such as the message, to another user device. For instance, a recommendation system can analyze messages stored in persistent storage and determine one or more messages to send to another user device. The determined messages can include the message that the user device provided to the micro-service. In this example, the recommendation system can determine that the other user device is associated with an account that follows, or has otherwise shown interest in, an account for the user device.

The recommendation system can provide the determined one or more messages to the other user device. This provision can cause the other user device to present a user interface that depicts content for the one or more messages, e.g., tweets. For instance, the other user device can present a user interface with a timeline that includes the content for the one or more messages.

By using the systems and methods described in this specification, the event processing pipeline can improve event processing, as described in more detail above. This can include improving the efficiency of the event processing pipeline.

The event processing pipeline described in this specification can process any kind of data stream. For instance, the event processing pipeline can be a stream processing pipeline that processes data that travels through different hops of systems. By embedding tracer events in the data stream, the stream processing pipeline can inspect and act on data in the stream in real-time or near real-time. In some examples, for use cases which have a feedback loop or action driven based on the data that passes through the stream, the use of tracer events can help achieve or improve the pipeline's performance in near real-time.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A computer-implemented method comprising:
generating, by a first system in an event processing pipeline that includes a plurality of systems within one or more layers a) including a last layer and b) at least some layers of which perform different event processing on an event that passes through the event processing pipeline after the event is processed by an initiating layer, tracer event data for a data event;
receiving, by a downstream system in the event processing pipeline that is included in a different layer from the layer that includes the first system, i) data for the data event and ii) the tracer event data for the data event;
processing, by the downstream system, the data event;
updating, by the downstream system, the tracer event data for the data event using metric data generated while the downstream system processed the data event;
providing, by the downstream system and for a second downstream system in the event processing pipeline, the updated tracer event data, wherein the second downstream system is included in a different layer from the layer that includes the downstream system;
after updating the tracer event data, receiving, by a last system in the last layer of the event processing pipeline and from another system in the event processing pipeline, i) the data event that has been processed at each of multiple different layers in the event processing pipeline, and ii) the updated tracer event data for the data event;
analyzing the updated tracer event data; and
causing a change to the event processing pipeline using a result of the analysis of the updated tracer event data.

2. The method of claim 1, wherein causing the change to the event processing pipeline comprises causing the change to one or more parameters for a system from one of the multiple different layers in the event processing pipeline using the result of the analysis of the updated tracer event data.

3. The method of claim 2, wherein causing the change to the one or more parameters for the system comprises causing auto-scaling for the system from one of the multiple different layers in the event processing pipeline using the result of the analysis of the updated tracer event data.

4. The method of claim 1, comprising:
storing, in a database, an entry for the data event that includes the updated tracer event data for the data event.

5. The method of claim 4, wherein storing the entry for the data event comprises storing, in the database, the entry for the data event that includes event data in a first column of the database and only tracer event data for the data event in a second column of the database.

6. The method of claim 4, wherein storing the entry for the data event comprises storing, in the database, the entry for the data event that includes event data with less restrictive permissions and tracer event data for the data event with more restrictive permissions that are more restrictive than the less restrictive permissions.

7. The method of claim 4, wherein:
receiving i) the data event and ii) the updated tracer event data for the data event comprises receiving, by the last system, a message that includes i) the data event that has been processed at each of multiple different systems in the event processing pipeline, and, ii) for each metrics-enabled system in the event processing pipeline, a field that includes tracer event data generated by the corresponding metrics-enabled system and an identifier for the corresponding metrics-enabled system; and
storing the entry for the data event comprises storing the entry for the data event that includes data for the data event and, for each of the metrics-enabled systems, a) the corresponding tracer event data generated by and, b) the identifier for, the corresponding metrics-enabled system.

8. The method of claim 1, comprising:
storing, in a database and for each of two or more data events that includes the data event, an entry for the respective event that includes the corresponding tracer event data for the respective event.

9. The method of claim 1, wherein receiving i) the data event and ii) the updated tracer event data for the data event comprises:
receiving, by the last system in the event processing pipeline, two or more data events including the data event; and
after receiving the two or more data events, receiving, by the last system in the event processing pipeline, a plurality of tracer event data a) that includes the tracer event data and b) is for the two or more data events including the data event.

10. The method of claim 9, wherein receiving the plurality of tracer event data for the two or more data events comprises receiving, by the last system in the event processing pipeline and after receiving the two or more data events, tracer event data for each of the two or more data events.

11. The method of claim 9, wherein receiving the plurality of tracer event data for the two or more data events comprises receiving, by the last system in the event processing pipeline and after receiving the two or more data events, data that includes, for each of multiple events from the two or more data events, i) an identifier for and, ii) tracer event data generated during processing of, the corresponding event.

12. The method of claim 9, wherein receiving the two or more data events comprises receiving a predetermined number of events.

13. The method of claim 9, wherein receiving the two or more data events comprises receiving, during a predetermined period of time, the two or more data events.

14. The method of claim 1, wherein receiving i) the data event and ii) the updated tracer event data for the data event comprises receiving, by the last system in the event processing pipeline, the data event that has been processed at each of multiple different systems in the event processing pipeline, at least some of which multiple different systems have platforms different from platforms of other systems included in the multiple different systems.

15. A non-transitory computer storage medium encoded with instructions that, when executed by one or more computers in a first system, cause the one or more computers to perform operations comprising:
generating, by the first system in an event processing pipeline that includes a plurality of systems within one or more layers a) including a last layer and b) at least some layers of which perform different event processing on an event that passes through the event processing pipeline after the event is processed by an initiating layer, tracer event data for a data event;
receiving, by a downstream system in the event processing pipeline that is included in a different layer from the layer that includes the first system, i) data for the data event and ii) the tracer event data for the data event;
processing, by the downstream system, the data event;
updating, by the downstream system, the tracer event data for the data event using metric data generated while the downstream system processed the data event;
providing, by the downstream system and for a second downstream system in the event processing pipeline, the updated tracer event data, wherein the second downstream system is included in a different layer from the layer that includes the downstream system;
after updating the tracer event data, receiving, by a last system in the last layer of the event processing pipeline and from another system in the event processing pipeline, i) the data event that has been processed at each of multiple different layers in the event processing pipeline, and ii) the updated tracer event data for the data event;
analyzing the updated tracer event data; and
causing a change to the event processing pipeline using a result of the analysis of the updated tracer event data.

16. The computer storage medium of claim 15, wherein causing the change to the event processing pipeline comprises causing the change to one or more parameters for a system from one of the multiple different layers in the event processing pipeline using the result of the analysis of the updated tracer event data.

17. The computer storage medium of claim 16, wherein causing the change to the one or more parameters for the system comprises causing auto-scaling for the system from one of the multiple different layers in the event processing pipeline using the result of the analysis of the updated tracer event data.

18. The computer storage medium of claim 15, the operations comprising:
storing, in a database, an entry for the data event that includes the updated tracer event data for the data event.

19. The computer storage medium of claim 18, wherein storing the entry for the data event comprises storing, in the database, the entry for the data event that includes event data in a first column of the database and only tracer event data for the data event in a second column of the database.

20. A first system comprising one or more computers and one or more storage devices on which are stored instructions that are operable, when executed by the one or more computers, to cause the one or more computers to perform operations comprising:
generating, by the first system in an event processing pipeline that includes a plurality of systems within one or more layers a) including a last layer and b) at least some layers of which perform different event processing on an event that passes through the event processing pipeline after the event is processed by an initiating layer, tracer event data for a data event;
receiving, by a downstream system in the event processing pipeline that is included in a different layer from the layer that includes the first system, i) data for the data event and ii) the tracer event data for the data event;
processing, by the downstream system, the data event;
updating, by the downstream system, the tracer event data for the data event using metric data generated while the downstream system processed the data event;
providing, by the downstream system and for a second downstream system in the event processing pipeline, the updated tracer event data, wherein the second downstream system is included in a different layer from the layer that includes the downstream system;
after updating the tracer event data, receiving, by a last system in the last layer of the event processing pipeline and from another system in the event processing pipeline, i) the data event that has been processed at each of multiple different layers in the event processing pipeline, and ii) the updated tracer event data for the data event;
analyzing the updated tracer event data; and
causing a change to the event processing pipeline using a result of the analysis of the updated tracer event data.
